(19) United States
(12) Patent Application Publication
(10) Pub. No.: US 2021/0045011 A1
(43) Pub. Date: Feb. 11, 2021

(54) OpenRAN and Virtualized Baseband Radio Unit

(71) Applicant: Parallel Wireless, Inc., Nashua, NH (US)

(72) Inventors: Rajesh Kumar Mishra, Westford, MA (US); Steven Paul Papa, Windham, NH (US); Eugina Jordan, Leominster, MA (US)

(21) Appl. No.: 16/991,014

(22) Filed: Aug. 11, 2020

Related U.S. Application Data
(60) Provisional application No. 62/885,309, filed on Aug. 11, 2019.

(51) Int. Cl. H04W 28/08; H04B 1/00; H04W 28/02

(52) U.S. Cl. CPC H04W 28/0804; H04W 88/085; H04W 28/0236; H04B 1/0003

(57) ABSTRACT

An Open Radio Access Network (OpenRAN) system is presented. In one embodiment the OpenRAN includes a plurality of software defined radios (SDRs), a Data Unit (DU) in communication with at least one SDR, a Control Unit (CU) in communication with at least one SDR, and a Virtualized Baseband Radio Unit (VBBU) in communication with at least one SDR, wherein different option splits are provided based on morphology and infrastructure availability of the OpenRAN.

### CROSS-REFERENCE TO RELATED APPLICATIONS

This application claims priority under 35 U.S.C. § 119(e) to U.S. Provisional Pat. App. No. 62/885,309, filed Aug. 11, 2019, titled “ OpenRAN and Virtualized Baseband Radio Unit”, which is hereby incorporated by reference in its entirety for all purposes. The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); US20180041934A1 (PWS-71850US03); US20200252996A1 (PWS-72548US01); US20200128414A1 (PWS-72570US01); and Ser. No. 16/853,745 (PWS-72611US01). This application also hereby incorporates by reference in their entirety U.S. Provisional Pat. Application No. 62/873,463, “5G Mobile Network Solution With Intelligent 5G Non-Standalone (NSA) Radio Access Network (RAN) Solution” filed Jul. 12, 2019; and U.S. Provisional Pat. Application No. 62/801,032, “Hybrid CWS Architecture,” filed Feb. 4, 2019.

### BACKGROUND

The RAN accounts for around 60% of CAPEX and 65% of OPEX in the cellular network. It follows that carriers need to maximize the value of their existing network assets before giving the green light to new investment. With its software-defined and cloud-native OpenRAN architecture, and with the world's largest Open RAN ecosystem, Parallel Wireless is leading the movement for wireless infrastructure innovation by delivering substantial cost savings to MNOs for building or maintaining both today's 4G/3G/2G networks and tomorrow's multi-vendor 5G networks. We strive to support you as you enable best-quality experiences to your end users and industries. Parallel Wireless has been recognized as a Best Performing Vendor at TIP Summit 2018 by both Telefonica and Vodafone.

### SUMMARY

An OpenRAN system is described. In one embodiment the system includes a plurality of software defined radios (SDRs); a Data Unit (DU) in communication with at least one SDR; a Control Unit (CU) in communication with at least one SDR; and a Virtualized Baseband Radio Unit (VBBU) in communication with at least one SDR, wherein different option splits are provided based on morphology and infrastructure availability of the RAN. In one embodiment the OpenRan is an outdoor OpenRAN and includes at least one Remote Radio Head (RRH) and a Virtualized Baseband Unit (vBBU) supporting multiple clusters based on Remote Radio Head cluster load. IN another embodiment the OpenRAN is an indoor OpenRAN and includes at least one Cellular Access Point (CAP) and an OpenRAN controller in communication with at least one CAP.

### BRIEF DESCRIPTION OF THE DRAWINGS

FIG. 1 is a diagram showing 3GPP compliant split options, in accordance with some embodiments.

FIG. 2 is a diagram showing an outdoor OpenRAN, in accordance with some embodiments.

FIG. 3 is a diagram showing coverage and capacity for large cells and small cells, in accordance with some embodiments.

FIG. 4 is a diagram showing an OpenRAN software suite composite VNF in accordance with some embodiments.

FIG. 5 is a diagram showing a migration strategy with a 5G native architecture, in accordance with some embodiments.

FIG. 6 is a diagram showing network slicing, in accordance with some embodiments.

FIG. 7 is a diagram showing a 3-sector macro tower, in accordance with some embodiments.

FIG. 8 is a diagram showing a single urban cell in a dense urban area, in accordance with some embodiments.

FIG. 9 is a schematic network architecture diagram for 3G and other-G prior art networks.

FIG. 10 is diagram of an enhanced eNodeB for performing the methods described herein, in accordance with some embodiments.

FIG. 11 is a diagram of is a coordinating server for providing services and performing methods as described herein, in accordance with some embodiments.

### DETAILED DESCRIPTION

The Open RAN Hardware Ecosystem (CWS)

The Parallel Wireless OpenRAN flexible and scalable architecture delivers disaggregation of hardware and software, along with decoupling of CU/DU functionality and support for any 3GPP compliant split. Our OpenRAN hardware ecosystem consists of Software Defined Radios (SDRs) that can be software upgraded to 5G for ease of deployment and lower cost, with no rip-and-replace. By separating RAN hardware from software, and by using commoditized GPP-based hardware, we believe we can kickstart the flywheel to enable an industry-wide ecosystem to drive down cost as a part of an end-to-end solution. Our software-based approach delivers ultra-high capacity access with absolutely no capacity or coverage limits and with the ability to cost-effectively extend resources to 5G, edge cloud, and MEC.

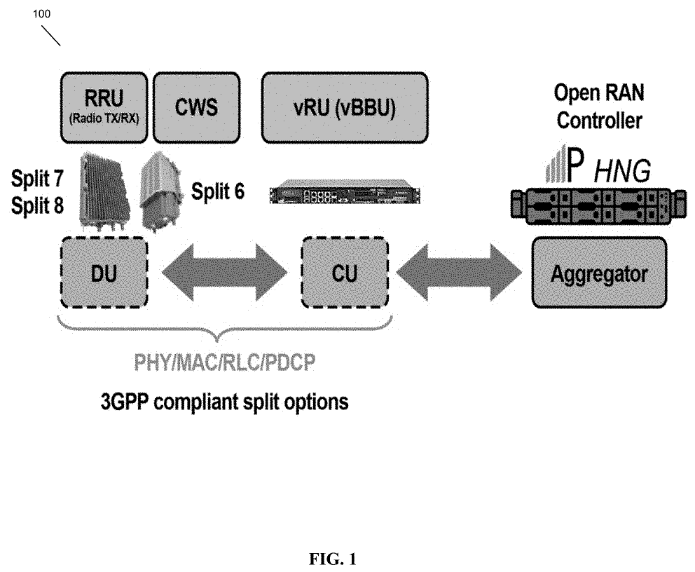

FIG. 1 shows diagram of 3GPP compliant split options 100.

Benefits to MNOs

Parallel Wireless's dynamic architecture is the only available solution for mobile operators to utilize different splits based on morphology and infrastructure availability, delivering:

Flexibility in selecting any split based on use case. For coverage deployments, higher splits are more desirable, while for dense urban areas, lower splits are typically the optimum solution for delivering maximum capacity. Parallel Wireless products enable different protocol layers to reside in different components based on fronthaul availability and morphology.

OpenRAN. Parallel Wireless's dynamic solution allows mobile operators to pick and choose different hardware vendors for DU and CU, helping to get the best performance at much lower cost.

Lowest TCO. By using different software implementations on the same RAN hardware, the cost of operations and ownership for mobile operators is reduced by up to 30%.

The need for providing both coverage and capacity and supporting growing data consumption, all with declining ARPUs, have placed tremendous pressure on MNOs to find the most efficient use of their allocated radio spectrum.

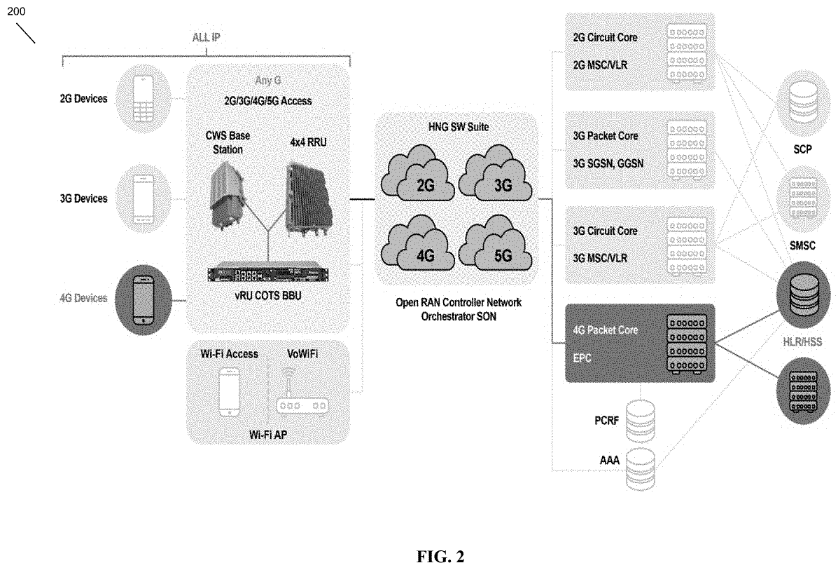

FIG. 2 shows an outdoor OpenRAN environment 200. The outdoor OpenRAN helps with spectrum optimization to provide improved profitability. The architecture includes:

Virtualized Baseband Unit (vBBU)

Based on Intel-based COTS (x86) hardware, this component provides High-PHY, MAC, RLC and PDCP functionality in a central fashion. It communicates to a cluster of RRHs (which contains RF and lower PHY) and supports multiple carriers based on the RRH cluster's load. The interface between vRU and RRH is based on Ethernet-based eCPRI. This architecture supports 4G today and is software-upgradable to 5G.

Remote Radio Heads (RRH)

The Parallel Wireless solution incorporates standard, off-the-shelf RRHs and small cells from different OEMs. These OpenRAN RRHs and small cells can be integrated into our solution with minimum integration effort, reducing the overall cost of ownership for mobile operators.

Parallel Wireless has developed extensive OpenRAN partnerships to support all use cases for coverage and capacity:

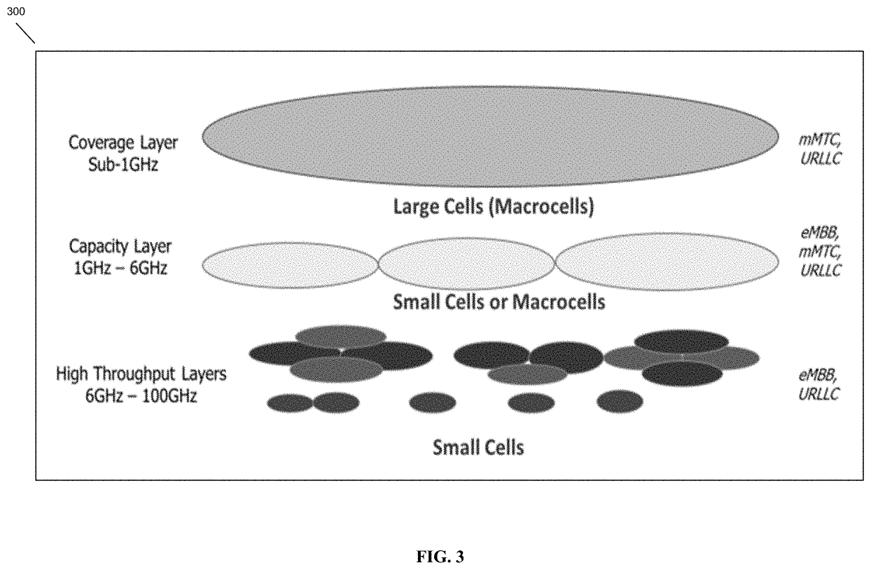

FIG. 3 is a diagram showing coverage and capacity for large cells and small cells 300, in accordance with some embodiments.

Macrocells

When operators build a network, they typically start by building a macro layer, mainly consisting of rooftop sites and towers to quickly deliver the largest possible coverage area. Parallel Wireless has an ecosystem of OpenRAN hardware to deliver the most efficient and powerful solutions to deliver coverage and capacity from 2×2, 4×4, 8×8 in different frequency bands—all software-defined and easily upgradable to 5G.

Massive MIMO

Moving from MIMO to massive MIMO, according to IEEE, involves making “a clean break with current practice,” as it requires a large number of service antennas over active terminals, as well as time-division duplex operation. “ . . . By focusing energy into ever smaller regions of space, [Massive MIMO brings] huge improvements in throughput and radiated energy efficiency.” The group calls out other benefits including cheaper parts, lower latency, simplification of the MAC layer, and robustness against intentional jamming. However, M-MIMO presents deployment challenges as well:

Heavier antennas, meaning that existing poles may not be able to bear the load, and any upgrades required will necessitate additional deployment costs. Power upgrades, as new active antennas will consume more power, which will be an additional operational cost as well as capital cost. Backhaul upgrades are necessary as well, as existing backhaul may not be able to cope with the projected massive increase in data traffic

With Parallel Wireless and its massive MIMO ecosystem partners, MNOs can select hardware based on their 5G deployment cases, budget and subscriber needs. Our OpenRAN Massive MIMO delivers:

A compact solution with perfect component synchronization that is easy to deploy. Support for any deployment scenario. Internal power consumption reduction to achieve total energy efficiency reductions.

Small Cells

5G networks will push the limits for small cell deployments. The Parallel Wireless OpenRAN approach solves the triple challenge of interference, mobility and deployment:

A combination of intra- and inter-frequency underlay and overlay cells will be a common practice in 5G networks. In a spatial densification deployment the OpenRAN controller manages intra-cell interferences, and for a vertical densification deployment it will coordinate all load-related handoffs and other functionalities to utilize different layers accordingly, thus improving overall system performance and frequency utilization.

The split concept (DU and CU) for 5G facilitates a simpler approach toward frequency coordination among different cells in a geographical area. This approach to small cell deployments enables different DUs with the same or different operating frequencies to be connected and coordinated through a single CU (Parallel Wireless vCU as a VNF in OpenRAN software suite).

All these interference mitigation techniques require tight coordination among different RRHs. Parallel Wireless OpenRAN coordinates with connected small cells directly, and also provides all required signaling to macro cells and reduces the overall system control signaling.

Besides interference issues, the densification of cellular networks can impact user experience due to increases in handoffs and related signaling loads. The increase of handoffs in a mobile system can directly impact the volume of signaling in the system and have a negative impact on overall user experience and system capacity. The Parallel Wireless OpenRAN controller dynamically executes parameter changes to optimize the user experience based on their mobility.

Indoor OpenRAN

Even those operators who are the most advanced in deploying Voice over LTE (VoLTE) technology realize that it will take many years before all voice traffic is carried over 4G. The necessary pairing of UE and core network VoLTE implementations means that 3G will remain an important voice solution for many years to come. This creates a dilemma for the operator, as clearly 4G/5G is the industry direction of travel, but 3G remains a critical voice technology. The Parallel Wireless 3G/4G OpenRAN solution for indoor/enterprise coverage is a 3GPP standards-based NFV-SDN-enabled solution easily scalable to suit any size enterprise to provide quality indoor coverage for voice and data.

The solution is based on cellular access point (CAP)/enterprise femtocells, and integrates 3G and 4G/LTE with real-time network orchestration, flexible scheduling, interference mitigation, resource optimization, traffic prioritization, and enterprise-grade security. The indoor OpenRAN controller provides orchestration enabled by real-time network SON, resource optimization and traffic mitigation. It also enables seamless mobility for users indoors and out, and makes network deployments fast and simple with no RF planning or complex system integration required.

The Cellular Access Point (CAP). The OpenRAN indoor hardware is a software-defined, multi-mode, multi-band enterprise femto that provides cellular single-mode 3G or 4G or multi-mode/multi-carrier 3G/4G access in the same form factor, and provides low cost, high QoS coverage for enterprises of all sizes. The CAP combines 3G and 4G/LTE functions into a single footprint using common network connectivity and power, greatly simplifying the installation and maintenance process. This helps to achieve the right level of deployment flexibility and attractive economics for service providers to deliver a wide variety of enterprise deployments with the lowest cost per unit and coverage, providing CAPEX savings of over 90%.

The indoor Open RAN solution uses Parallel Wireless's OpenRAN controller, the HNG, which provides enterprise gateway functionalities with many 3G/4G/Wi-Fi functions virtualized, including femto gateway, small cell gateway, and other functionalities. Normally the cost of these functionalities would be a significant extra. The controller software itself reduces the CAPEX by 90%, as it includes many gateway functionalities needed for enterprise solutions to manage licensed and unlicensed spectrum. The controller runs on any x86 server, with a well-understood CAPEX of a few thousands of dollars with plenty of capacity for high performance. The controller can be deployed in a remote or local cloud, and one HNG can serve many enterprises. OPEX will also be reduced with the HNG, as it will optimize the enterprise network, mitigate traffic, etc.

Benefits to MNOs

Easy and cost-effective installation. With the Parallel Wireless Open RAN controller, deployment can be reduced from days to hours, while eliminating the need for RF planning and extensive system integration. In under a day, a Tier 1 was able to install the whole system in a medium-size enterprise building, without specialized installers or RF planning required. The controller configured the nodes without any involvement from IT personnel (plug-and-play). The Parallel Wireless solution offered comprehensive self-organizing network (SON) capability, ensuring that cells were self-configuring (including neighbor lists and physical cell ID).

Quality end-user experience, including voice. The network orchestrator functionality of Parallel Wireless software platform also optimizes radio performance, e.g., inter-cell interference coordination, handover optimization between the indoor cells and indoor cells and neighboring macros for seamless mobility, and frequent handover mitigation, which results in better QoS for data and voice for end users. The dual-mode cell supports Circuit Switched Fallback (CSFB) and VoLTE voice, enabling the operator to invest in the future while ensuring it can deliver the legacy services for high-quality voice coverage.

5G OpenRAN (child to products). 5G radio, or NR (New Radio), improves spectral efficiency and delivers unprecedented network capacity. 5G New Radio technology is based on flexible OFDM waveforms and multiple access techniques, optimized for various 5G services, applications, and deployment use cases. 5G (NR) features are defined by various 3GPP standards, with first phase completion in Rel-15 and second phase in Rel-16.

The Parallel Wireless OpenRAN software suite for 5G(NR) increases spectrum efficiency, traffic capacity, throughput, reliability, number of connected devices and reduces end-to-end latency. This technology enables MNOs to unlock and support diverse use cases such as Fixed Wireless Access (FWA), Enhanced Mobile broadband (eMBB), Massive Machine Type Communications (mMTC), and Ultra-Reliable Low Latency Communications (URLLC).Parallel Wireless OpenRAN outdoor hardware is software-upgradable to 5G, delivering these enhanced capabilities at much lower cost.

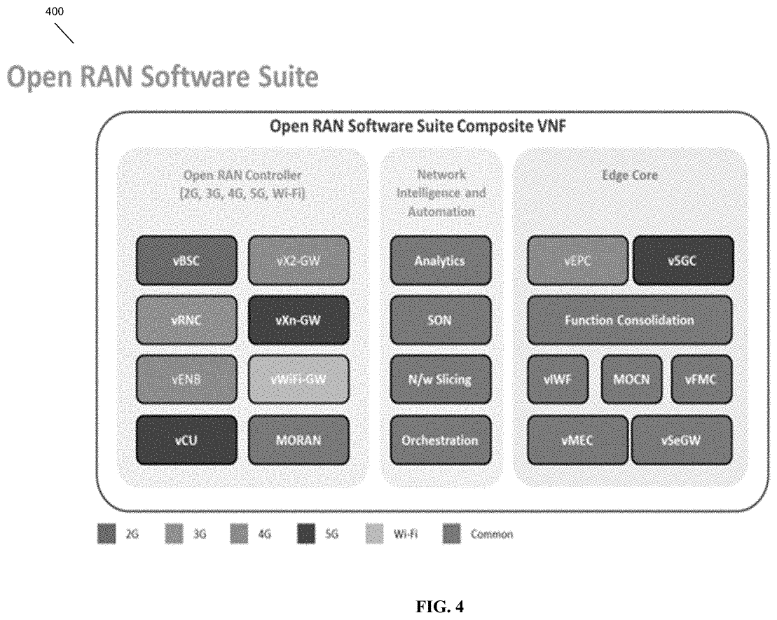

FIG. 4 shows a block diagram of the OpenRAN Software Suite 400. The Parallel Wireless OpenRAN software suite enables the complete decoupling of hardware and software functionality. This functional separation enables the software suite to support any protocol split between DUs and CUs based on available backhaul/fronthaul options. Different RAN element functionalities are also consolidated on the platform, reducing complexity and making overall network maintenance simpler and less resource-intensive. Running on COTS x86-64 servers with minimum hardware dependencies, our world's first and only OpenRAN software suite consists of the following components:

OpenRAN Controller: This performs the functions of an OpenRAN controller and is responsible for radio connection management, mobility management, QoS management, edge services, and interference management for the end user experience. Different RAN element functionalities are consolidated on this software platform, reducing complexity and making overall network maintenance simpler and less resource-intensive. As currently released, the OpenRAN controller module can virtualize a vBSC/2G gateway, 3G gateway/vRNC, 4G gateway/X2 gateway, Wi-Fi gateway, or any combination thereof. The fully virtualized and scalable controller functionality supports the E2 interface and works with multi-vendor RAN. As a result, it helps create a multi-vendor, open ecosystem of interoperable components for the various RAN elements and vendors. It can be software-upgraded to 5G RAN Controller functionality as non-standalone (NSA) and Standalone (SA) as the 5G standards are finalized and stabilized. Being a 5G native platform, it provides a smooth migration path to 5G utilizing any migration option.

Network Orchestration and real-time SON: This provides complete RAN orchestration, including self-configuration, self-optimization, and self-healing. All new radio units are self-configured by the software, reducing the need for manual intervention, which will be key for 5G deployments of Massive MIMO and small cells for densification. The self-optimization is responsible for necessary optimization related tasks across different RANs, utilizing available RAN data from all RAN types (macros, Massive MIMO, small cells) from the Analytics module. The predictive approach utilized by the Parallel Wireless platform, in contrast to the legacy reactive optimization approach, improves user experience and increases network resource utilization, key for consistent experience on data intensive 5G networks.

Network Sharing enabler: Infrastructure sharing will be a key for 5G networks. Parallel Wireless OpenRAN software suite enables MOCN/MORAN by having the ability to view the traffic and route to the proper core. This then allows RAN sharing to happen without complication to any of the home networks. The HetNet Gateway simply requires connections to each core and thereafter handles the heavy lifting of routing the traffic properly.

Benefits to MNOs. By disaggregating hardware and software, the Parallel Wireless OpenRAN software platform creates a unified architecture through abstraction of traditional RAN and core network functions on a COTS server, and brings 5G software benefits (i.e. low latency and network slicing) across the network for ALL G (2G/3G/4G/5G), resulting in: G Agility: a unified software-enabled architecture for past, present, and future Gs; Deployment flexibility for 5G, 4G, 4G, 2G through consolidation of network functions and RAN/core interfaces. Openness across RAN and core through fully 3GPPP compliant virtualized interfaces, enabling interop between all vendors and allowing for modernization of networks or selection of best of breed for 5G; Real-time responsiveness to subscriber needs through edge-centric architecture to deliver best performance for voice and data, outdoors or indoors, across 2G/3G/4G/5G, thereby reducing subscriber churn; and OPEX reduction through network automation: with plug-n-play configuration and hands-free optimization, professional services spend on deployment or maintenance is reduced by up to 80% to deliver much lower OPEX across past, present, and future networks, even 5G networks.

The Parallel Wireless OpenRAN software suite is fully virtualized. It can be deployed as a VNF (it is a Composite VNF, which includes a federation of VMs behaving like a single logical entity). The software is ETSI's MANO compliant, and agnostic to the underlying data center infrastructure so can use any Intel x86 server, and can be installed with all major market leading hypervisors (Linux KVM, VMware ESXi). It can be managed via any standards-compliant VNF Manager (VNFM), as well as any NFV Orchestrator (NFVO). Partnerships are in place with Intel, RedHat, VMware, HPE, and Dell. SRIOV, DPDK, PCI Passthrough is fully supported.

5G Solutions. 5G networks will have to support a number of services, many of them with different and almost orthogonal performance requirements.

Three major service categories defined for 5G are: Enhanced Mobile Broadband (eMBB): This has been billed as the main driver for initial 5G rollouts. Not only are end users expecting to receive faster speeds, they expect more data allowances for a lower price. 5G meets end-user expectations while delivering spectral efficiency for the operator. The Parallel Wireless OpenRAN software suite plays an important role here by abstracting core functionality and catering for different deployment options, based on the SP's roadmap.

Massive Machine Type Communications (mMTC): LTE-M and NB-IoT, standardized as part of 3GPP Release-13 version of LTE, are being enhanced to work with 5G. There is no special focus for mMTC in 5G currently but this will play an important role in the 3GPP Release-16 version of 5G. The Parallel Wireless software suite will help to manage the myriad of IoT devices and mitigate interference and reduce signaling strain on the core.

Ultra-Reliable and Low-Latency Communications (URLLC): This feature promises to make 5G appealing to many new verticals, thereby providing SPs with new source of revenues. There is no focus for URLLC in 5G currently but it will play an important role in 3GPP Release-16 version of 5G. This feature also requires 5GC, as new slices would need to be created for different verticals to meet their requirements.

In addition to the above use cases, fixed wireless access (FWA) has also emerged as an important use case for quite a few operators. While there are no special features that have been added specifically for FWA, features such as 3D beamforming and wider bandwidths make 5G an attractive option for FWA. Parallel Wireless OpenRAN is increasingly being deployed not only provide mobile broadband services but also for fixed wireless deployments using 4G LTE. It is foreseen that this trend will continue with 5G.

With Parallel Wireless OpenRAN architecture, MNOs can deploy 5G networks with 5G-native architecture. The Parallel Wireless OpenRAN architecture is software-based, so it is inherently 5G-native, and a network could be switched to 5G when standards are finalized with a simple software upgrade, maximizing the original 4G investment on the RAN or core.

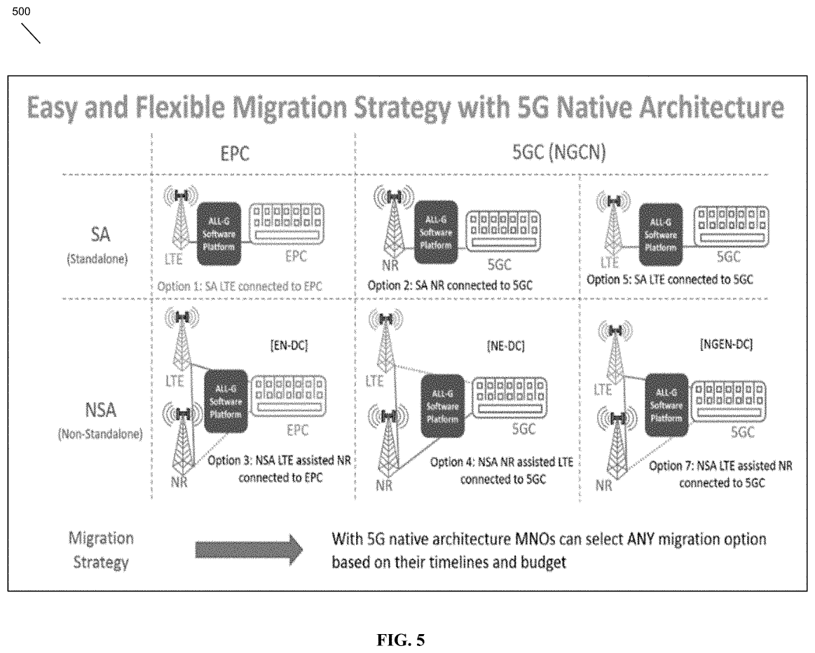

FIG. 5 is a diagram showing a migration path 500 with a 5G native architecture. Simplify 5G and reduce deployment cost through 5G Open RAN. The orchestration and real-time SON capabilities provide real-time optimization and network automation reducing the maintenance cost and enabling new business cases for 5G. In addition, spectrum sharing, network sharing can be enabled through MORAN and MOCN functionality to maximize spectrum and reduce 5G deployment cost.

Deliver 5G experiences for consumers and industries. With features of Parallel Wireless's OpenRAN architecture, the introduction of network slicing and control and user plane separation (CUPS) on any 5G NSA core supports 5G design architectures.

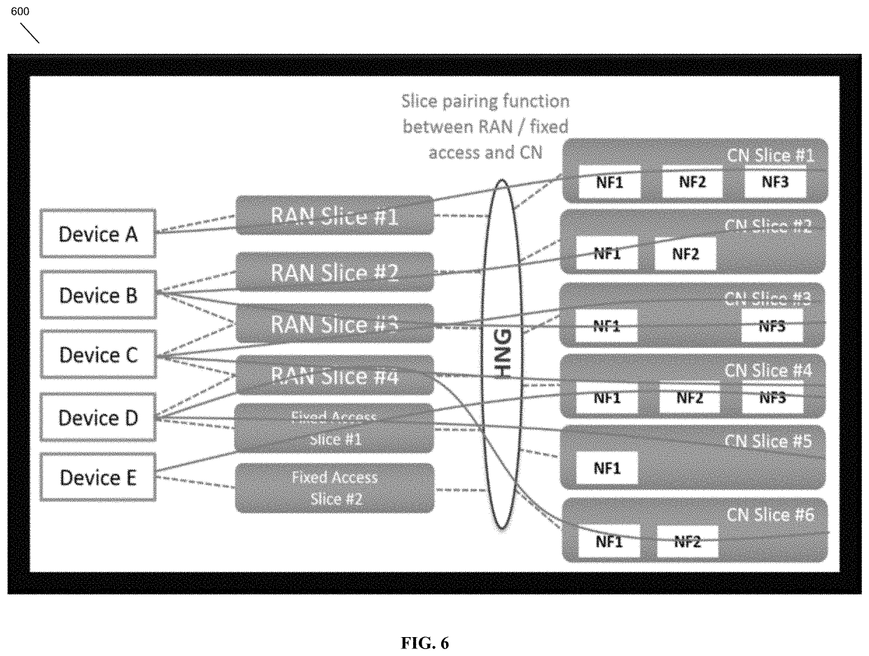

FIG. 6 shows network slice pairing between RAN/fixed access and CN 600. The OpenRAN software suite manages each slice, delivering the required QoS, security, latency characteristics. In addition, it will deliver dynamic capacity and throughput for optimal performance for 5G data intensive applications through scalable software-based architecture.

Coverage

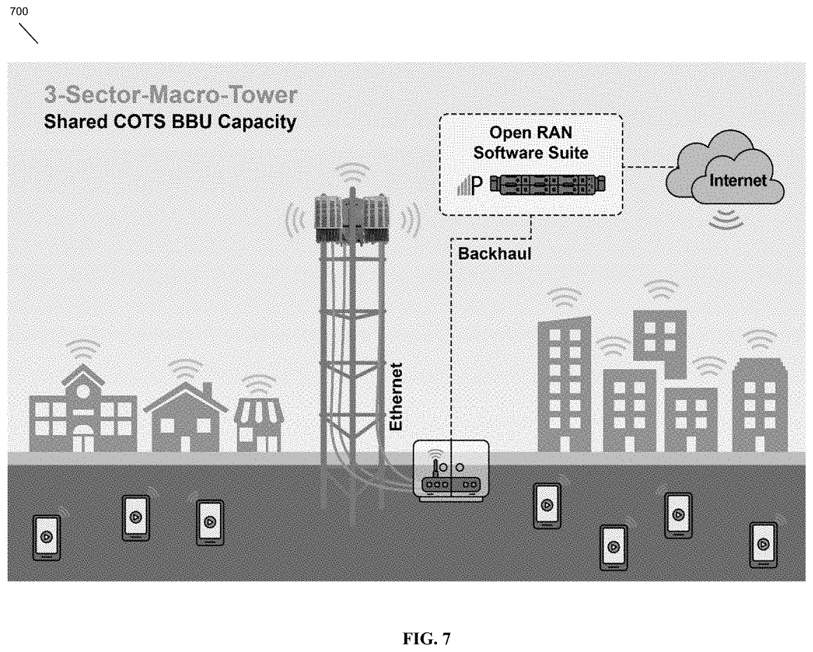

FIG. 7 shows a diagram using a 3-sector-macro-tower 700. Enhanced mobile broadband will be the first commercial application of 5G and can help operators deliver coverage everywhere from rural to suburban to most dense urban locations. Parallel Wireless OpenRAN can support all those deployment scenarios at the lowest TCO and can be deployed on accelerated timeline.

The base station depicted in FIG. 7 utilizes a functional split between the radio head at the top of the tower (DU) and the baseband unit on the ground/in the cabinet (CU). The depicted baseband unit is able to provide baseband services for three radio heads. Fronthaul connects the three radio heads with the baseband unit. Backhaul is used to connect the baseband unit to the core network via an OpenRAN server running software as described elsewhere herein and in the documents incorporated by reference.

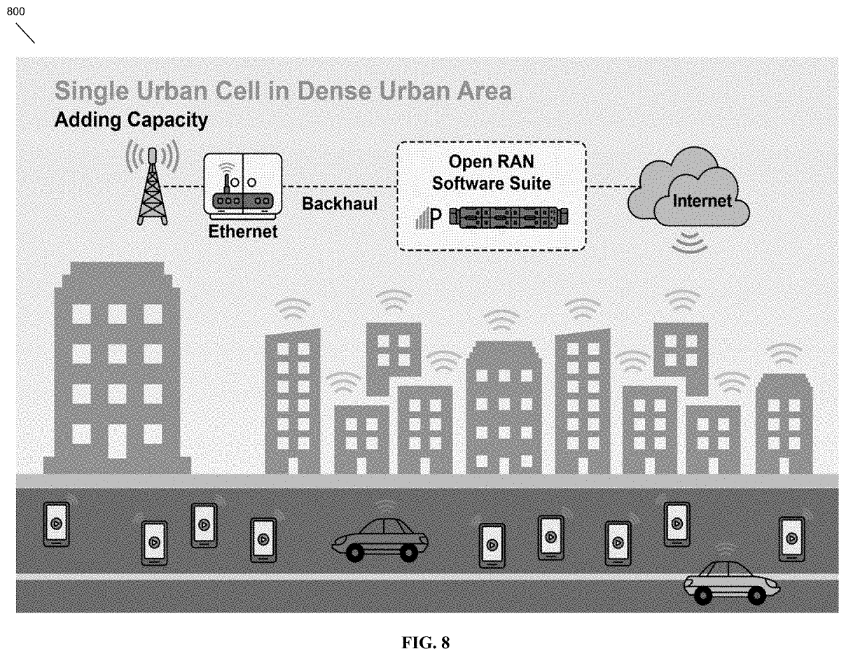

FIG. 8 shows a diagram of a single urban cell deployment 800. The base station shown includes a radio head atop a tower (which in some embodiments may be on top of a building), coupled to a baseband unit in a cabinet over Ethernet, coupled to a core network via backhaul and via an OpenRAN server running software as described elsewhere herein. In some embodiments, the same baseband unit as shown in FIG. 7 may be used to operate the radio head in FIG. 8, simply by modifying its software or, in some cases, upgrading its hardware processing capability. Different radios can provide different frequency band support, in some embodiments. Different numbers of radios, different waveforms, different RATs, different modulations, etc. can be supported by the same baseband unit, in some embodiments. This enables a single baseband unit to be used flexibly and at scale by a network operator in both urban and non-urban scenarios, and to be upgraded with additional or different radios based on need without requiring cumbersome upgrades of the BBU. Noteworthy is that the BBU described herein is not limited to providing service from only one RAT, such as 4G or 5G, but is able to flexibly provide service to different RATs with a software upgrade. This is possible using software stacks and FPGAs at the BBU that implement decoding and baseband processing for the different RATs.

Capacity

As MNOs deploy 5G networks, how people connect in urban areas will drive solutions that operators will deploy. Easy to install, low-cost and high-performing cloud-native Parallel Wireless OpenRAN supports macro or small cell deployments for densification and delivers superior end user QoS for consumers and industries.

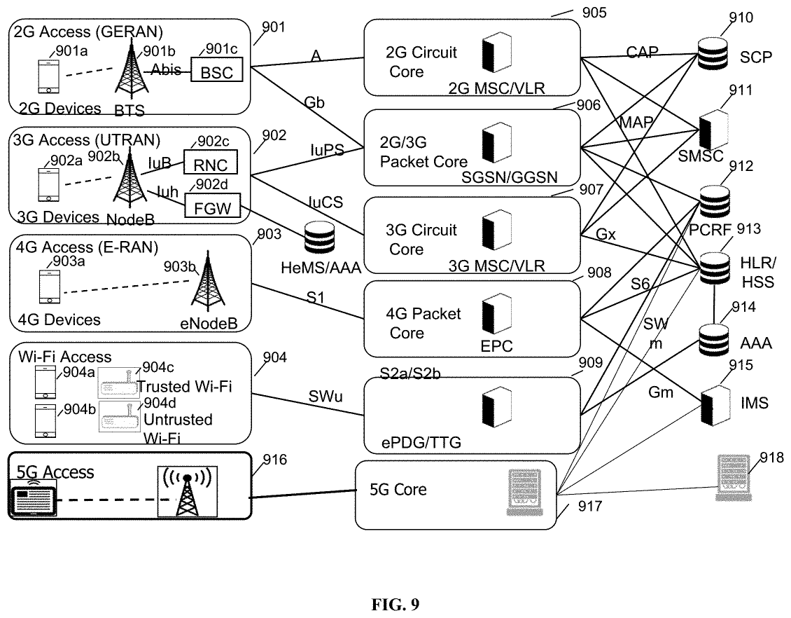

FIG. 9 is a schematic network architecture diagram for 3G and other-G prior art networks. The diagram shows a plurality of “Gs,” including 2G, 3G, 4G, 5G and Wi-Fi. 2G is represented by GERAN 901, which includes a 2G device 901a, BTS 901b, and BSC 901c. 3G is represented by UTRAN 902, which includes a 3G UE 902a, nodeB 902b, RNC 902c, and femto gateway (FGW, which in 3GPP namespace is also known as a Home nodeB Gateway or HNBGW) 902d. 4G is represented by EUTRAN or E-RAN 903, which includes an LTE UE 903a and LTE eNodeB 903b. Wi-Fi is represented by Wi-Fi access network 904, which includes a trusted Wi-Fi access point 904c and an untrusted Wi-Fi access point 904d. The Wi-Fi devices 904a and 904b may access either AP 904c or 904d. In the current network architecture, each “G” has a core network. 2G circuit core network 905 includes a 2G MSC/VLR; 2G/3G packet core network 906 includes an SGSN/GGSN (for EDGE or UMTS packet traffic); 3G circuit core 907 includes a 3G MSC/VLR; 4G circuit core 908 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 930, the SMSC 931, PCRF 932, HLR/HSS 933, Authentication, Authorization, and Accounting server (AAA) 934, and IP Multimedia Subsystem (IMS) 935. An HeMS/AAA 936 is present in some cases for use by the 3G UTRAN. The diagram is used to indicate schematically the basic functions of each network as known to one of skill in the art, and is not intended to be exhaustive. For example, 5G core 917 is shown using a single interface to 5G access 916, although in some cases 5G access can be supported using dual connectivity or via a non-standalone deployment architecture.

Noteworthy is that the RANs 901, 902, 903, 904 and 936 rely on specialized core networks 905, 906, 907, 908, 909, 937 but share essential management databases 930, 931, 932, 933, 934, 935, 938. More specifically, for the 2G GERAN, a BSC 901c is required for Abis compatibility with BTS 901b, while for the 3G UTRAN, an RNC 902c is required for Iub compatibility and an FGW 902d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

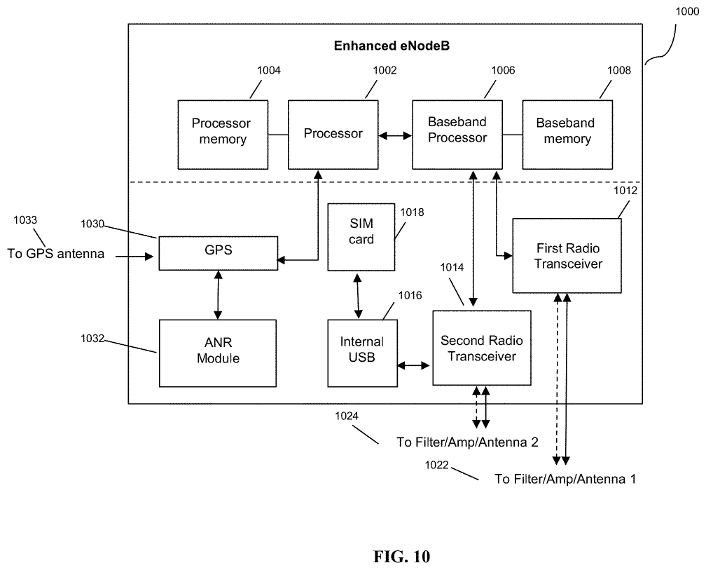

FIG. 10 shows an enhanced eNodeB for performing the methods described herein, in accordance with some embodiments. eNodeB 1000 may include processor 1002, processor memory 1004 in communication with the processor, baseband processor 1006, and baseband processor memory 1008 in communication with the baseband processor. Mesh network node 1000 may also include first radio transceiver 1010 and second radio transceiver 1014, internal universal serial bus (USB) port 1016, and subscriber information module card (SIM card) 1018 coupled to USB port 1016. In some embodiments, the second radio transceiver 1014 itself may be coupled to USB port 1016, and communications from the baseband processor may be passed through USB port 1016. The second radio transceiver may be used for wirelessly backhauling eNodeB 1000. The enhanced eNodeB is suitable for functional splits as shown in, e.g., FIGS. 7-8.

Processor 1002 and baseband processor 1006 are in communication with one another. Processor 1002 may perform routing functions, and may determine if/when a switch in network configuration is needed. Baseband processor 1006 may generate and receive radio signals for both radio transceivers 1010 and 1014, based on instructions from processor 1002. In some embodiments, processors 1002 and 1006 may be on the same physical logic board. In other embodiments, they may be on separate logic boards. Functional splits will enable some baseband processing to happen within the enhanced eNodeB and some baseband processing to happen within a separate BBU (CU). In some embodiments, all baseband processing will happen at a BBU and the baseband processor will instead be replaced by a fronthaul bus processor.

Processor 1002 may identify the appropriate network configuration, and may perform routing of packets from one network interface to another accordingly. Processor 1002 may use memory 1004, in particular to store a routing table to be used for routing packets. Baseband processor 1006 may perform operations to generate the radio frequency signals for transmission or retransmission by both transceivers 1010 and 1010. Baseband processor 1006 may also perform operations to decode signals received by transceivers 1010 and 1014. Baseband processor 1006 may use memory 1008 to perform these tasks.

The first radio transceiver 1010 may be a radio transceiver capable of providing LTE eNodeB functionality, and may be capable of higher power and multi-channel OFDMA. The second radio transceiver 1014 may be a radio transceiver capable of providing LTE UE functionality. Both transceivers 1010 and 1014 may be capable of receiving and transmitting on one or more LTE bands. In some embodiments, either or both of transceivers 1010 and 1014 may be capable of providing both LTE eNodeB and LTE UE functionality. Transceiver 1010 may be coupled to processor 1002 via a Peripheral Component Interconnect-Express (PCI-E) bus, and/or via a daughtercard. As transceiver 1014 is for providing LTE UE functionality, in effect emulating a user equipment, it may be connected via the same or different PCI-E bus, or by a USB bus, and may also be coupled to SIM card 1018. First transceiver 1010 may be coupled to first radio frequency (RF) chain (filter, amplifier, antenna) 1022, and second transceiver 1014 may be coupled to second RF chain (filter, amplifier, antenna) 1024.

SIM card 1018 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 1000 is not an ordinary UE but instead is a special UE for providing backhaul to device 1000.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 1010 and 1014, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 1002 for reconfiguration.

A GPS module 1030 may also be included, and may be in communication with a GPS antenna 1032 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 1032 may also be present and may run on processor 1002 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

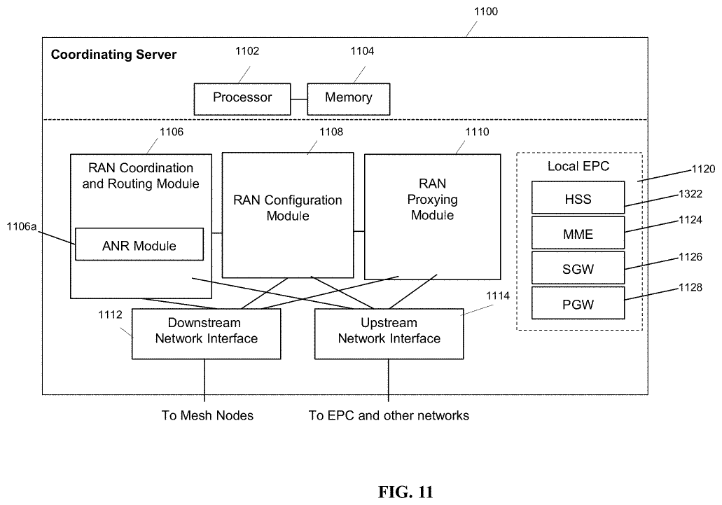

FIG. 11 is a coordinating server for providing services and performing methods as described herein, in accordance with some embodiments. Coordinating server 1100 includes processor 1102 and memory 1104, which are configured to provide the functions described herein. Also present are radio access network coordination/routing (RAN Coordination and routing) module 1106, including ANR module 1106a, RAN configuration module 1108, and RAN proxying module 1110. The ANR module 1106a may perform the ANR tracking, PCI disambiguation, ECGI requesting, and GPS coalescing and tracking as described herein, in coordination with RAN coordination module 1106 (e.g., for requesting ECGIs, etc.). In some embodiments, coordinating server 1100 may coordinate multiple RANs using coordination module 1106. In some embodiments, coordination server may also provide proxying, routing virtualization and RAN virtualization, via modules 1110 and 1108. In some embodiments, a downstream network interface 1112 is provided for interfacing with the RANs, which may be a radio interface (e.g., LTE), and an upstream network interface 1114 is provided for interfacing with the core network, which may be either a radio interface (e.g., LTE) or a wired interface (e.g., Ethernet).

Coordinator 1100 includes local evolved packet core (EPC) module 1120, for authenticating users, storing and caching priority profile information, and performing other EPC-dependent functions when no backhaul link is available. Local EPC 1120 may include local HSS 1122, local MME 1124, local SGW 1126, and local PGW 1128, as well as other modules. Local EPC 1120 may incorporate these modules as software modules, processes, or containers. Local EPC 1120 may alternatively incorporate these modules as a small number of monolithic software processes. Modules 1106, 1108, 1110 and local EPC 1120 may each run on processor 1102 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the 5G standard or the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 5G technology is described, the inventors have understood that other RATs have similar equivalents, such as a gNodeB and eNB in 4G. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. An Open Radio Access Network (OpenRAN) system, comprising:
a plurality of software defined radios (SDRs);
a Data Unit (DU) in communication with at least one SDR;
a Control Unit (CU) in communication with at least one SDR; and
a Virtualized Baseband Radio Unit (VBBU) in communication with at least one SDR, wherein different option splits are provided based on morphology and infrastructure availability of the OpenRAN.

2. The OpenRAN of claim 1 wherein the RAN is an outdoor OpenRAN and includes at least one Remote Radio Head (RRH) and a Virtualized Baseband Unit (vBBU) supporting multiple clusters based on Remote Radio Head cluster load.

3. The OpenRAN of claim 2 wherein the at least one RRH contain RF and lower PHY.

4. The OpenRAN of claim 2 further comprising a plurality of small cells in communication with at least one RRH and/or a plurality of large cells in communication with at least one RRH.

5. The OpenRAN of claim 2 wherein the large cells provide a coverage layer sub-1 GHz.

6. The OpenRAN of claim 2 wherein the large cells and small cells provide a capacity layer between 1 GHz and 6 GHz.

7. The OpenRAN of claim 2 wherein the small cells provide high throughput layers between 6 GHz and 100 GHz.

8. The OpenRAN of claim 1 wherein the RAN is an indoor OpenRAN and includes at least one Cellular Access Point (CAP) and an OpenRAN controller in communication with at least one CAP.

9. The indoor OpenRAN of claim 8 wherein the CAP combines 3G and 4G/LTE functions using common network connectivity and power.

10. The indoor OpenRAN of claim 8 wherein the OpenRAN controller virtualizes 3G, $g and WiFi functions.

11. The indoor OpenRAN of claim 8 wherein the OpenRAN controller manages radio connection management, mobility management, QoS management, edge services, and interference management for the end user experience.
